(19) United States
(12) Patent Application Publication
(10) Pub. No.: US 2024/0083751 A1
(43) Pub. Date: Mar. 14, 2024

(54) METHODS FOR SYNTHESIS OF CARBON-NANOTUBES FROM ASPHALTENES

(71) Applicant: Olanrewaju Tanimola, Sugarland, TX (US)

(72) Inventor: Olanrewaju Tanimola, Sugarland, TX (US)

(21) Appl. No.: 17/931,106

(22) Filed: Sep. 9, 2022

(51) Int. Cl. C01B 32/166

(52) U.S. Cl. CPC C01B 32/166; B82Y 30/00

(57) ABSTRACT

The present invention discloses a method for synthesizing graphene by eliminating one or more functional groups from a 1D carbon allotropes of graphene having a lattice structure selected from an orthorhombic system, a monoclinic system, and a triclinic system. The present invention discloses a method for synthesizing graphene by eliminating one or more functional groups from a network of one or more 1D nanostructures having a lattice structure formed by an asymmetric structural unit (CxHyF) where x=6, or 7, 3<=y<=9 and F is one or more functional group.

### CROSS-REFERENCE TO RELATED APPLICATIONS

This application claims the benefit of the filing date of and priority to: U.S. Provisional Application Ser. No. 62/035,140 entitled “Methods for Synthesis of Graphene Derivatives and Functional Materials from Asphaltenes”, filed Aug. 10, 2015, Confirmation No. 9603; the entire contents of the said provisional application is hereby incorporated by reference.

### STATEMENT REGARDING FEDERALLY SPONSORED RESEARCH OR DEVELOPMENT

Not Applicable.

### BACKGROUND OF THE INVENTION

Since their reported discovery by Iijima in 1991, carbon-nanotubes (CNTs) have continued to attract considerable interest from a wide range of industries. This is often attributed to their remarkable combination of high electrical and thermal conductivity, as well as outstanding strength and stiffness. The tensile specific strength, and specific modulus of CNTs at the nanoscale are far higher than state-of-the-art lightweight structural materials such as carbon fiber and steel. Their tensile strength is 100 times greater than steel, yet it is about 6 times lighter. These interesting features potentially enlarge the design space for structures dramatically and enable the development of multifunctional materials and components. Most CNT production processes are carried out in a vacuum or with processed gases. These include arc discharge, thermal plasma jet and chemical vapor deposition (CVD). Among these techniques, the CVD and arc discharge growth of CNTs which can be carried-out in a vacuum or at atmospheric pressure are prominent in the open market. Despite more than two decades of carbon nanotubes research, there exists limited understanding of its growth mechanism and manufacturing scale-up. The maturation of CNTs-based manufacturing is faced with many concerns, specifically related to batch-to-batch variability, high cost of production, and minimal market footprint. As well as poor yield (e.g., low carbon utilization and rapid catalyst inactivation), slow production rate (e.g., low nucleation efficiencies), unacceptable variations in material quality, and lack of real-time process control.

There is a need to develop a cost-effective, scalable, and sustainable way of producing carb on-nanotubes.

Moreover, the impact of CO2 on climate change has ignited new developments in materials processing. In recent years, tremendous efforts are being committed towards developing synthetic approach that captures and utilizes CO2 in a sustainable manner.

There is a need for a climate change mediation approach which could be in the form of CO2 usage.

### SUMMARY OF THE INVENTION

The present invention is a method for synthesizing CNT comprising: contacting an asphaltene composition with CO2 wherein a carboxylated asphaltene derivative is produced; contacting the carboxylated asphaltene derivative with one or more modifying agents or reducing agents wherein a CNT composition is produced; purifying the CNT composition to isolate a pure CNT material. The present invention is a method for synthesizing CNT by eliminating one or more functional groups from a graphene derivative. The graphene derivative comprises a network of one or more ID nanostructures having a lattice structure formed by an asymmetric structural unit (CxHyF) where x=6, or 7, 3<=y<=9 and F is one or more functional groups comprising a selection from one or more nitrogen groups, one or more sulfur groups, one or more halogen groups, a chelating groups, one or more aromatic groups, one or more phosphorous groups, one or more ligands, one or more thiol groups, one or more hydroxyl groups, one or more NH2 groups, one or more sulfonate groups, one or more azo groups, one or more nitro groups, one or more SO3H groups, one or more heteroatoms, one or more sulfide groups, one or more hydrogen groups, one or more OH groups, one or more OR groups, one or more NHOR groups, one or more COR groups, one or more SO2 groups, one or more NO2 groups, one or more CN groups, one or more NR3 groups, one or more amide groups, one or more carbonyl groups, one or more oxygen groups, one or more ester groups, one or more carboxyl groups, one or more alkyl groups, one or more acyl groups, one or more carboxylate groups, or any combination thereof.

The present invention is a method for synthesizing CNT by eliminating one or more functional groups from a graphene derivative. The graphene derivative comprises a network of one or more ID nanostructures having a lattice structure selected from an orthorhombic system, a monoclinic system, and a triclinic system.

The CNTs described in present invention include CNTs that vary in wall type, semiconducting capability, metal presence and purity chemical and organic synthesis of CNTs from asphaltenes

An object of this invention is to develop a chemical and organic synthesis of CNTs from an asphaltene derivative

### BRIEF DESCRIPTION OF THE DRAWINGS

FIG. 1 Shows the arrangement of the molecules in the lattice structure of a graphene derivative having a network of one or more ID nanostructured formed by a unit cell of C7H1004S.

FIG. 2 shows the supramolecular assembly of a highly ordered hydrogen network of structure of a graphene derivative having a network of one or more ID nanostructured formed by a unit cell of C7H1004S

FIG. 3 shows Process flow chart of present invention

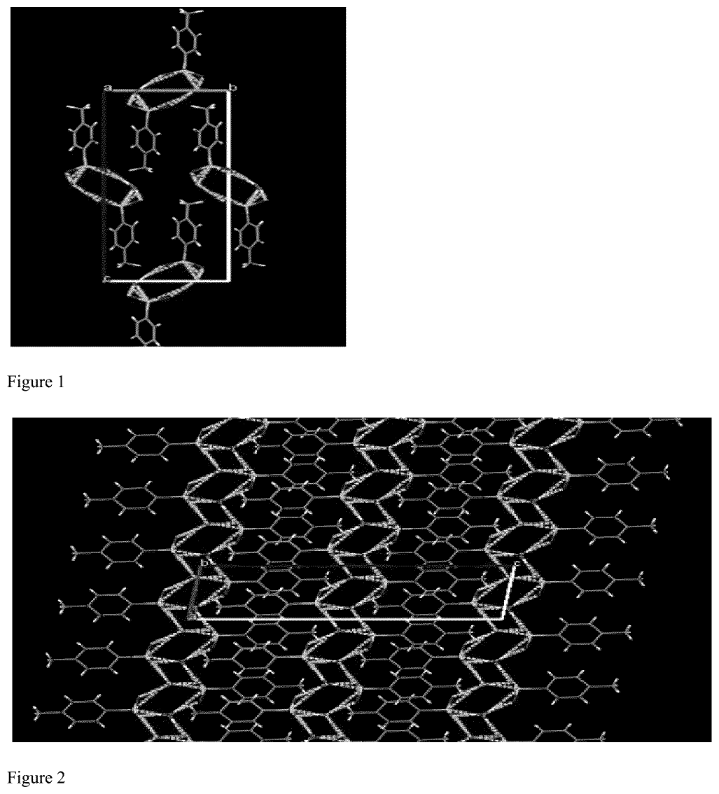

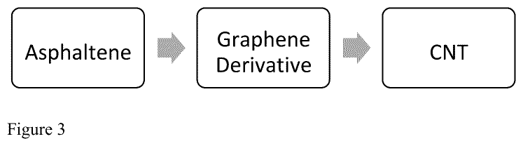

### DETAILED DESCRIPTION OF THE INVENTION

It is an object of the present invention to provide a method for synthesizing CNT from asphaltenes that are modified or derivatized by aromatization, functionalization, surface modification, dimerization, electrophilic aromatic substitution, nucleophilic aromatic substitution, desymmetrization, esterification, reduction, oxidation, and combinations thereof.

It is an object of the present invention to provide a method for synthesizing CNT from asphaltenes that includes (a) isolation or separation of asphaltene from a source material, (b) fractionation or purification of an asphaltene composition, (c) derivatization or functionalization of the asphaltene composition to produce an asphaltene product or asphaltene derivative, and/or (d) isolation or purification of the asphaltene product or asphaltene derivative.

It is an object of the present invention to provide a method for synthesizing CNT from asphaltenes that includes methods that involve hydrothermal, solvothermal and chemical methods for the derivatization of asphaltene.

It is an object of the present invention to provide a method for synthesizing CNT from an oxidized asphaltenes composition.

It is an object of the present invention to provide a method for synthesizing CNT from asphaltenes comprising the use of stoichiometry to produce CNT to address current limitations to CNT thus producing a defect free CNT material for standardization and industrial advancement.

It is an object of the present invention to provide a sustainable method for synthesizing CNT from asphaltenes at low-cost, improved quality, and controlled physiochemical properties.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open ended and do not exclude additional, unrecited elements or method steps.

Other objects feature and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description

### A. Isolation/Separation of Asphaltenes

There are a number of methods for characterizing crude oil components, as well as isolating and identifying asphaltenes. In certain methods the isolation of asphaltenes is initiated by precipitation of asphaltenes followed by the purification of the asphaltene precipitate. In a further aspect the asphaltenes can be solubilized prior to or after precipitation.

One example of isolating asphaltene from crude oil comprises dissolving crude oil in heptane. Stirring the heptane/crude oil mixture for about 48 hours at room temperature. Filtering the mixture through filter paper and rinsing the filtrate using toluene. The filtered solution is dried and a crude asphaltene composition collected from the filter.

The crude asphaltene preparation can then be further purified. Crude asphaltene is dissolved in toluene and stirred for about 5 hours. The stirred solution is filtered, using for example filter paper no.40. Purified asphaltene passes through the filter paper while impurities remain on the filter paper. The filtered asphaltene solution is dried at room temperature. The result is purified asphaltene that is typically a black shiny product. This product can then be further derivatized using the methods described herein.

Depending on the asphaltene starting material, it should be appreciated that the structure of asphaltene extracted from contemplated methods may vary considerably.

### B. Asphaltene Derivatization

Asphaltene can be modified or derivatized by aromatization, functionalization, surface modification, dimerization, electrophilic aromatic substitution, nucleophilic aromatic substitution, desymmetrization, esterification, reduction, oxidation, and combinations thereof.

Generally the method comprises one or more steps selected from (a) isolation or separation of asphaltene from a source material, (b) fractionation or purification of an asphaltene composition, (c) derivatization or functionalization of the asphaltene composition to produce an asphaltene product or asphaltene derivative, and/or (d) isolation or purification of the asphaltene product or asphaltene derivative.

Another embodiment of the invention describes methods that involve hydrothermal, solvothermal and chemical methods for the derivatization of asphaltene.

The present invention utilizes oxidation and reduction processing procedures. Asphaltenes can be separated from a source by differential solubility.

### C. Methods for Making CNT

It is an object of the present invention to provide a method for synthesizing CNT from asphaltenes that includes an asymmetric unit provides precise details of the atoms and molecules that make up the building block of layered nanostructure. In addition, present invention discloses method of controlling the number of layers or isolating individual atomic planes from a bulk composition like asphaltene.

It is an object of the present invention to provide a method for synthesizing CNT from asphaltenes that discloses a reproducible and scalable production process of transforming asphaltene into CNT with control over number of layers, size, and morphology.

It is an object of the present invention to provide a method for synthesizing CNT from asphaltene via a chemical exfoliation approach including the using of a dispersant.

It is an object of the present invention to disclose a method of producing CNT comprising: providing a dispersed asphaltene composition comprising an asphaltene material, and one or more surfactants; refluxing the dispersed asphaltene composition to form a refluxed asphaltene derivative; performing chemical exfoliation on the refluxed asphaltene derivative to extract a carbon-nanotubes material.

It is an object of the present invention to disclose a method of producing CNT comprising: providing a dispersed asphaltene composition comprising an asphaltene material, and one or more dispersants; refluxing the dispersed asphaltene composition to form a refluxed asphaltene derivative; performing chemical exfoliation on the refluxed asphaltene derivative to extract a carbon-nanotubes material.

The surfactant comprises a sulfonic acid composition or alkyl sulfonic acid oxonium salt.

The dispersant comprises a selection from p-alkylphenols, p-alkylbenzenesulfonic acid, or alkyl sulfonic acid.

Prior art described surfactants; WO 2013/165869 is incorporated herein for all purposes of the processing.

It is an object of the present invention to provide a method for synthesizing CNT from asphaltene via a surface growth technique including depositing a graphene derivative on a substrate.

It is an object of the present invention to provide a method for synthesizing CNT from asphaltene via a solution phase growth technique.

It is an object of the present invention to provide a method for synthesizing CNT from a graphene derivative via a vapor deposition technique including-chemical vapor deposition (CVD) or Large area CVD.

It is an object of the present invention to provide a method for synthesizing CNT by contacting a reducing agent with an asphaltene derivative. The asphaltene derivative is selected from the group consisting of a refluxed asphaltene derivative, a modified asphaltene derivative, or a controlled asphaltene derivative.

It is an object of the present invention to provide a method for synthesizing CNT by eliminating one or more functional groups from a graphene derivative. The graphene derivative comprises a network of one or more ID nanostructures having a lattice structure formed by an asymmetric structural unit (CxHyF) where x=6, or 7, 3<=y<=9.

It is an object of the present invention to provide a method for synthesizing CNT by eliminating one or more functional groups from a graphene derivative. The graphene derivative comprises a network of one or more ID nanostructures having a lattice structure selected from an orthorhombic system, a monoclinic system, and a triclinic system

It is an object of the present invention to disclose a CNT composition comprising a network of one or more ID nanostructures having a lattice structure comprising a selection from an asymmetric unit (CxHy)n, where x=6, y=6, an orthorhombic system, a monoclinic system, or a triclinic system.

It is an object of the present invention to provide a method for synthesizing CNT involving an asphaltene derivative that includes refluxing an dispersion for a period of time to form a refluxed asphaltene derivative, contacting the refluxed asphaltene derivative with a modifying agent or a basic solution to form a modified asphaltene derivative, contacting the modified asphaltene derivative with a controlling agent or an acidic solution to form a quenched asphaltene derivative.

It is an object of present invention to provide method for synthesis of CNT including the use of one or more additives selected from but not limited to nitric acid, sulfuric acid, aromatic solvent, polar solvent, methanol, water, peroxide, formic acid, benzene, toluene, naphthalene, nitrobenzene sulfonic acid, linear alkyl sulfonic, polytetrafluoroethylene, sodium nitro sulfonic acid, sodium dodecyl sulfate, cetyltrimethylammoniumbromide, phospholipid, lignin, sulfuric acids, ammonia, taurine, tetrahydrofuran, sulfur trioxide, carboxylic acid, acetic acid, carboxylic acids, sulfonic acids and derivatives, carbonic acids, nitro-sulfonic acids, oleic acid, methyl cellulose, diethylene glycol, polyoxyethylrne sorbitan monolaurate, hydrogen peroxide, oxalic acid, perchloric acid, iron bromide, iron chloride, phosphoric acid, hydrofluoric acid, chlorosulfonic acid, trifluoromethanesulfonic acid, nickel, iron, vanadium, permanganate, oleum, chloride, chlorite, nitrite, potassium permanganate, methanol, acetone, water, propanol, isopropanol, dimethyl sulfoxide, polyethylene glycol (PEG), polymer copolymer (PEtOz-Pcl), alkyl phenol, water, Dodecyl benzenesulphonic acid, methanol, tetrachloromethane, taurine, methionine, trichloromethane, tetrahydrofuran, N-(3dimethylaminopropyl), N′ethylcarbodiimide hydrochloride, N′ hydroxyl succinimide, polylysines (PLs), sodium dodecyl benzenesulfonate, platinum, sodium oleate, cysteine, homocysteine, or any mixtures thereof.

It is an object of present invention to provide method for synthesis of CNT including the use of one or more modifying agents to the tune the surface or interphase of the refluxed asphaltene derivative. A modifying agent may be introduced to alter the edges of the asphaltene emulsion. This may result in structural morphology changes. In certain aspect a modifying agent performs several operations that include without limitation addition of functional group(s), elimination of the functional group(s), and substitution of functional group(s).

The modifying agent comprises without limitation metal catalyst, basic solution, a reducing agent, a salt solution, metal oxides, sulfides, hydrides and any combination thereof. The modifying agent is selected from any of sodium chloride, sodium hydroxide, ammomum hydroxide, hydrochloric acid, tetrahydrofuran, ammo triazole, dimethylformamide, dimethylsulfoxide, phosphines, phosphites, sulfites, sulfides, hydrosulfites, borohydrides, boranes, hydroxylamine, lithium alhydride, sodium nitrite, hydrochloric acid, copper bromide, copper cyanide, potassium iodide, borohydrides, hydrochloric acid, cyanoborohydrides, aluminum hydrides, hydroquininone, hydrogen dimethylhydrazine, N,N-dimethylhydroxylamine, methylamine, dioxane, amino acids, dimethylamine, trimethylamine taurine, methionine, potassium hydroxide, tin, methanol, alkali sulfide, distilled water, or any mixtures thereof.

It is an object of present invention to provide method for synthesis of CNT including the use of one or more controlling agents for pH control. The selection of a controlling agent is dependent on the pH of the solution. Controlling agent is selected from any of hydrochloric acid, sodium bicarbonate, methanol, dimethyl sulfoxide, sodium hydroxide, potassium hydroxide, tetrahydrofuran, dimethylformamide, alkali sulfide, dimethylsulfoxide, phosphines, phosphites, sulfites, sulfides, dioxane, hydrosulfites, borohydrides, boranes, distilled water, sodium bicarbonate or any mixtures thereof.

In certain aspects the intercalating solvent (surfactant) is an oxidative acid or a mixture of oxidative acids. An oxidative acid can be sulfuric acid, perchloric acid, nitric acid, or mixtures thereof. An acid component can be present at final concentration of 0.0001, 0.0005, 0.001, 0.005, 0.01, 0.05, 0.1, 0.2, 0.3, 0.4, 0.5, 0.6 M to 0.5, 0.6, 0.7, 0.8, 0.9, IM during reflux. An asphaltene/solvent/oxidative acid mixture can be refluxed at a temperature of 25, 30, 35, 40, 45, 50, 55, 60, 65, 70, 75, 80, 85, 90, 95, 100 C or greater, indiliding all values and ranges there between. The pH of the solution, which during reflux is less than 2 can be controlled by neutralizing the mixture with a base, such as diluted NaOH, KOH, or the like (0.0001 M to IM). Quenching can be accomplished by addition of an acidic solution (e.g., HCl) (0.0001 M to IM). Varying the parameters results in variation of the attribute of the resulting product (e.g., structural morphology, lattice parameter, degree of orderliness etc.). Therefore all variables (e.g., solvents, temperature range, concentration, volume, ratio, time etc.) can be varied to some degree to alter the characteristics of the products.

The products of the dispersant method exhibit a wide range of material properties. Characterization studies indicate the presence of material having dual properties. The dual properties observed in a single product include mechanical, size (small and large PAH), optical (short and long wavelength absorption), shape (rod like and disc like molecules), liquid crystalline phases (discotic and calamitic). Such products are referred to as lastotenes. The lastotene phases may be further separated into two graphene derivatives by a suitable separation technique. Examples of the techniques are chromatography, liquid-liquid extraction, bilayer membrane, distillation, and other separation techniques. The invention envisions the adaption of several techniques for separation.

Another strategy is to design a method for the separation of these phases from the starting material using dispersant/solvent method.

In one embodiment this method may be regarded as a functionalization, oxidation, and reduction process. It involves physisorption and chemisorption at asphaltene-solvent interface, which facilitates conjugation of a fragment of asphaltenes with an active component of the solvent. It facilitates an affinity to asphaltenes which may result in functional groups being absorbed either on the surface of the asphaltene aggregation or become bonded with the polar group of asphaltene molecules, in certain aspects both are likely to occur. In this method, the interaction between asphaltenes and organic salts promotes strong donors of the hydrogen bonding and may also instill stability on asphaltenes structure.

The introduction of solvents in this method promotes chemisorption and physisorption of molecules of asphaltenes and an active functional group of the solvents. The type of functional group present in the final product is dependent on the choice of solvent.

The CNT material of present invention is formed by contacting an asphaltene derivative or a starting material with one reducing agents or reductants.

The CNT material of present invention is having a lattice structure selected from a hexagonal system, an orthorhombic system, a monoclinic system, and a triclinic system.

The asphaltene derivative of present invention includes a selection from refluxed asphaltene derivative, modified asphaltene derivative, neutralized asphaltene derivative, controlled asphaltene derivative, quenched asphaltene derivative, and functionalized asphaltene derivative.

The starting material of the present invention of present invention comprises a network of one or more ID carbon nanostructures having a cl-spacing or interlayer distance less than or equal to 1.367 nm, wherein the network comprises a lattice structure selected from the group consisting of an orthorhombic system, a monoclinic system, and a triclinic system, wherein the lattice structure is an asymmetric structural unit (ASU)n wherein n is greater than zero and the ASU is represented by a formula of (CxHyF) wherein x=6 or 7, 3: Sy: S6 and F is one or more functional groups.

The one or more functional groups is a selection from an electron donor, an electron donor, or a combination thereof.

The one or more functional groups is selected from the group consisting of one or more nitrogen groups, one or more sulfur groups, one or more hydroxyl groups, one or more OR groups, one or more NHOR groups, one or more halogen groups, one or more halide groups, one or more NR2 groups, one or more SO3H groups, one or more sulfide groups, one or more azo groups, one or more sulfonate groups, one or more CN groups, one or more CH3 groups, one or more N₂O₄ groups, one or more 03 SH30 groups, one or more SO2 groups, one or more NO2 groups, one or more NR3 groups, one or more amide groups, one or more carbonyl groups, one or more oxygen groups, one or more ketone groups, one or more ester groups, one or more carboxyl groups, one or more alkyl groups, one or more acyl groups, one or more carboxylate groups, and combinations thereof.

The reducing agent comprises without limitation a selection from hydrogen sulphide, sodium borohydride, hydrazine, a de-functionalizing agent, a decarboxylating agent, desulfonating agent, a denitrating agent, a modifying agent, an alkaline solution, sodium citrate, amino acids, sugars, ascorbic acid, thermal energy, a metal, zinc, magnesium, primary amine, secondary amine, tertiary amme, copper, sodalime, electromagnetism, polyphenols, tea, microorganisms, or a mixture thereof.

The modifying agent comprises without limitation metal catalyst, basic solution, a salt solution, metal oxides, sulfides, hydrides and any combination thereof.

The modifying agent is selected from the group consisting of sodium chloride, sodium hydroxide, ammomum hydroxide, hydrochloric acid, tetrahydrofuran, amino triazole, dimethylformamide, dimethylsulfoxide, phosphines, phosphites, sulfites, sulfides, hydrosulfites, borohydrides, boranes, hydroxylamine, lithium alhydride, sodium nitrite, hydrochloric acid, copper bromide, copper cyanide, potassium iodide, borohydrides, hydrochloric acid, cyanoborohydrides, aluminum hydrides, hydroquininone, hydrogen dimethylhydrazine, N,Ndimethylhydroxylamine, sulfurous acid, methylamine, dioxane, ammo acids, dimethylamine, trimethylamine taurine, methionine, potassium hydroxide, tin, methanol, alkali sulfide, distilled water, or mixtures thereof.

As stated in known art, vapor deposition process can improve the purity of the product. Also, a more ordered lattice structure can be obtained using chemical deposition method. The present invention incorporates deposition methods of known including chemical vapor deposition, thermal vapor deposition, etc.

It is an object of the present invention to provide a method for synthesizing a carbon nanotube material, the method comprising, providing a composition comprising a network of one or more 1D carbon nanostructures by eliminating one or more functional groups from a graphene derivative. having a lattice structure formed by an asymmetric structural unit (CxHyF) where x=6, or 7, 3<=y<=9, where F is one or more functional group comprising a selection from one or more oxygen groups, one or more nitro-groups, one or more sulfur groups, one or more carboxylic groups, one or more halogens, one or more alkyl groups, or a combination thereof; processing the said composition by performing one or more processing steps selected from contacting with one or more reducing agents, contacting with heat, contacting with thermal energy, contacting with electromagnetic wave, contacting with one or more dehydrating agents, contacting with one or more dehalogenation agent, contacting with one or more dehydrogenating agents, heating, pressurizing, freezing, or any combinations thereof.

It is the object of the present invention to disclose a method comprising (i) providing an asphaltene composition, or a carbon composition comprising a network of one or more 1D carbon nanostructures having a lattice structure selected from the group consisting of an orthorhombic system, a monoclinic system, and a triclinic system, wherein the lattice structure is an asymmetric structural unit (ASU)n wherein n is greater than zero and the ASU is represented by a formula of (CxHyF) wherein x>=6, y>=1, and F is one or more functional groups comprising a selection from one or more oxygen groups, one or more nitro-groups, one or more sulfur groups, one or more carboxylic groups, one or more alkyl groups, or a combination thereof (ii) contacting the asphaltene composition, and the carbon composition with one or more modifying agents or one or more reducing agents to form a reduced carbon composition comprising a network of one or more 1D carbon nanostructures having a hexagonal lattice structure and an asymmetric structural unit (ASU)n wherein n is greater than zero and the ASU is represented by a formula of (CxHy) wherein x>=6, y>=3, or (CxHy) (iii) refluxing the carbon composition or the reduced carbon composition to form a carbon nanotube composition (iv) performing one or more separation techniques to separate a selection from the carbon composition, the reduced carbon composition or the refluxed product to produce a carbon nanotube material (v) performing one or more separation techniques to produce a carbon-nanotube product, and one or more byproducts comprising a selection from an organic product, a hydrogen product, and a fuel product. The separation techniques comprise a selection from chromatography, liquid-liquid extraction, bilayer membrane, distillation, and other separation techniques. The invention envisions the adaption of several techniques for separation.

The present invention relates to a method comprising: (i) providing a carbon composition comprising a network of one or more 1D nanostructures having a lattice structure, wherein the lattice structure is an asymmetric structural unit (ASU)n wherein n is greater than zero and the ASU is represented by a formula of (CxHyF) wherein x>=6, y>=1, and F is one or more functional groups comprising one or more alkyl groups. (ii) performing one or more process steps selected from the group consisting of contacting the carbon composition with one or more hydro alkylation reagents, contacting with one or more dealkylation reagents, contacting with thermal energy, contacting with steam, contacting with one or more dehydrogenating agents, heating, pressurizing, freezing, or a combination thereof (iii) Performing one or more separation techniques to produce a carbon-nanotube product and one or more byproducts selected from an organic product, a hydrogen product, and a fuel product.

It is an object of the present invention to disclose a method of producing a carbon-nanotube material, the method comprising (i) providing a carbon composition comprising a network of one or more nanostructures having a lattice structure comprising a selection from an asymmetric unit (CxHy)n, where x=6, y=6, an orthorhombic system, a monoclinic system, or a triclinic system (ii) providing a nanocomposition comprising a network of one or more

ID carbon nanostructures having a lattice structure formed by an asymmetric structural unit (CxHyF) where x=6, or 7, 3<=y<=9, where F is one or more functional groups comprising a selection from one or more oxygen groups, one or more hydrogen group, one or more nitro-groups, one or more sulfur groups, one or more heteroatoms, one or more carboxylic groups, one or more alkyl groups, or a combination thereof. (iii) Performing one or more process steps of modifying the carbon composition, or the nanocomposition, wherein the modifying comprises performing one or more process steps selected from contacting with one or more reducing agents, contacting with heat, contacting with thermal energy, contacting with electromagnetic wave, contacting with one or more dehydrating agents, contacting with one or more dehydrogenating agents, contacting with one or more spinning object, stretching, carbonizing, sizing, surface treatment, heating, pressurizing, freezing, or any combinations thereof.(iv) Performing one or more purification steps to produce a carbon fiber product, and by one or more byproducts selected from an organic product, a fuel product, and a hydrogen product.

It is an object of the present invention to disclose a method comprising (i) contacting an asphaltene composition with one or more additives to form an asphaltene colloid (ii) providing a carbon composition comprising a network of one or more carbon nanostructures having a lattice structure comprising a selection from an asymmetric unit (CxHy)n, where 6<=x<9 y=6, the lattice structure is selected from hexagonal, orthorhombic or monoclinic (iii) modifying the asphaltene colloid, or the carbon composition by performing one or more processing steps selected from contacting with one or more reducing agents, contacting with heat, contacting with thermal energy, contacting with electromagnetic wave, contacting with one or more dehydrating agents, contacting with one or more dehydrogenating agents, contacting with one or more spinning object, stretching, carbonizing, sizing, surface treatment, heating, pressurizing, freezing, or any combinations thereof. (iv) modifying the asphaltene colloid, or the carbon composition by performing one or more processing steps of contacting with a selection from metal oxide, metal, copper, silica, steam, thermal energy, pressure, or a combination thereof (v) performing one or more purification steps to produce an aromatic product, a nanocarbon fiber product, and a hydrogen product.

It is an object of the present invention to disclose a method comprising providing an asphaltene composition and performing one or more process steps selected from (i) processing the asphaltene composition by contacting with one or more additives to form a metal comprising product, and a demineralized nanocarbon compositions comprising a network of one or more 1D nanostructures having a lattice structure selected from an orthorhombic system, a monoclinic system, and a triclinic system. (ii) contacting the asphaltene composition with one or more additives to form a nanocolloid comprising a network of one or more 1D nanostructures having a lattice structure selected from an orthorhombic system, a monoclinic system, and a triclinic system. (iii) modifying the demetallized nanocarbon composition, or the nanocolloid to form a modified nanocolloid, wherein the modifying comprises performing one or more processing steps selected from contacting with one or more reducing agents, contacting with heat, contacting with thermal energy, contacting with electromagnetic wave, contacting with one or more dehydrating agents, contacting with one or more dehydrogenating agents, contacting with one or more desulfonation reagents, contacting with one or more neutralizing agents, contacting with one or more denitration reagents, contacting with one or more spinning object, stretching, carbonizing, sizing, surface treatment, heating, pressurizing, freezing, contacting with one or more metal oxide, metal, contacting with copper, contacting with silica, or a combination thereof. (iv) purifying the modified nanocolloid by performing one or more purification steps to produce a nanocarbon fiber, and a byproduct comprising an organic product, or a hydrogen product.

It is an object of the present invention to disclose a method comprising providing an asphaltene composition, or a demineralized carbon composition and performing one or more process steps selected from (i) forming a nanocolloid composition by contacting the asphaltene composition, or the demineralized carbon composition with one additives, wherein the nanocolloid composition comprises a network of one or more 1D nanostructures having a lattice structure selected from an orthorhombic system, a monoclinic system, and a triclinic system. (ii) modifying the nanocolloid composition to form a 1D composition by having a lattice structure with a unit cell (CxHy)n or (CxHyR)n wherein x=6 or 7, 3<y<=7, R is a functional group comprising at least one heteroatom, wherein the modifying comprises performing one or more process steps selected from contacting with one or more reducing agents, contacting with heat, contacting with thermal energy, contacting with electromagnetic wave, contacting with one or more dehydrating agents, contacting with one or more dehydrogenating agents, contacting with one or more desulfonation reagents, contacting with one or more neutralizing agents, contacting with one or more denitration reagents, contacting with one or more spinning object, stretching, carbonizing, sizing, surface treatment, heating, pressurizing, freezing, or any combinations thereof. (iii) controlling the nanocolloid composition, or the nanotube composition by performing one or more processing steps of contacting with a selection from metal oxide, metal, copper, silica, steam, thermal energy, pressure, or a combination thereof. (iv) Performing one or more purification steps to produce a nanocarbon fiber, and a byproduct comprising an organic material, or a hydrogen product.

The asphaltene composition in the present invention includes but is not limited to a fractionated asphaltene, a metalized asphaltenes, modified asphaltene, a crude asphaltene, a purified asphaltene, coal, synthetic coal, demineralized coal, bitumen, synthetic bitumen, oil-sand, asphaltene solution, mixed asphaltene, metalized asphaltene, acid purified natural carbon, salt-purified natural carbon, base-purified natural carbon.

It is an object of the present invention to explore a method or a processing step that includes heat treatment under one or more conditions selected from below 100° C., above 100° C., below 500° C., above 500° C., below 1000° C., or above 1000° C., below 5 bar, above 5bar, below 20 bar, above 20 bar, and any combinations thereof.

The present invention incorporates prior arts on dehalogenation, dehydrogenation, dehydration, dealkylation, denitration, desulfonation, and reduction.

The present invention incorporates WO2014088922A1, U.S. Pat. No. 6,040,490A, and US201220310024A1.

### EXAMPLES

The following examples as well as the figures are included to demonstrate preferred embodiments of the invention. It should be appreciated by those of skill in the art that the techniques disclosed in the examples or figures represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Asphaltene Preparation

Numerous methods of processing asphaltene sources (e.g., crude oil) are recognized in art. The extraction of asphaltene process includes precipitation and purification. One of the extraction processes employed for the production of asphaltene from crude oil is given below. Materials—Maya crude oil, Heptane (99.8% purity, Toluene (99.9% purity), glass wares, paper filters (40 microns), Nitric acid (EMD NX-0409-2), Sulfuric acid (Fischer A300212), NaOH (Fischer. Cas No: 1310-73-2), HCl (37.5% Cone.).

Precipitation—Asphaltenes are extracted from crude oil: 100 ml of thoroughly mixed crude oil was dissolved in four liters of heptane and subjected to magnetic stirring for 48 hours at room temperature. The homogeneous mixture was filtered (40 m filter paper) and rinse using toluene. The product solution was collected in recrystallization dishes and kept for drying under a hood for 24 hours. About 14 g of dried impure (crude) asphaltene was collected.

Purification—The collected crude asphaltene was dissolved in 400 ml of toluene and placed on a magnetic stirrer for 5 hours, using filter paper no. 40 to separate mixtures. In this case, the purified asphaltene was passed through the filter paper, while the impurities remained on the filter. The collected purified asphaltene solution was poured into a large beaker and allowed to dry under a hood for 24 hours at room temperature. The result is a black shiny compound (asphaltene).

### Example 1

### Synthesis of CNT from Asphaltenes

200 mg of asphaltenes is dissolved in 50 ml of a reagent comprising toluene to form an asphaltene solution. The resulting solution is contacted with an oxidizing agent to form a network of oxidized ID nanostructure. The ID nanostructured composition is treated with ascorbic acid and purified to isolate CNT.

### Example 2

### Synthesis of CNT from Asphaltenes

200 mg of asphaltenes is dissolved in 50 ml of a reagent comprising toluene to form an asphaltene solution. The resulting solution is contacted with a mixed acid to form a network of one or more oxidized ID nanostructures. The oxidized ID nanostructured composition is contacted with NaOH and purified. The resulting product is contacted with ascorbic acid.

I claim:

1. A method for synthesis of carbon nanotube comprising:
Providing a composition comprising network of one or more 1D nanostructures having a d-spacing or interlayer distance less than or equal to 1.367 nm; contacting the composition with one or more reducing agent.
wherein the network comprises a lattice structure selected from the group consisting of an orthorhombic system, a monoclinic system, and a triclinic system, wherein the lattice structure is an asymmetric structural unit (ASU)n wherein n is greater than zero and the ASU is represented by a formula of (CxHyF) wherein x=6 or 7, 3<y<6 and F is one or more functional groups selected from the group consisting of one or more nitrogen groups, one or more sulfur groups, one or more hydroxyl groups, one or more OR groups, one or more NHOR groups, one or more halogen groups, one or more halide groups, one or more NR2 groups, one or more SO3H groups, one or more sulfide groups, one or more azo groups, one or more sulfonate groups, one or more CN groups, one or more CH3 groups, one or more N2O4 groups, one or more 03 SH30 groups, one or more SO2 groups, one or more NO2 groups, one or more NR3 groups, one or more amide groups, one or more carbonyl groups, one or more oxygen groups, one or more ketone groups, one or more ester groups, one or more carboxyl groups, one or more alkyl groups, one or more acyl groups, one or more carboxylate groups, and combinations thereof.

2. The method according to claim 1, wherein the reducing agent comprises a selection from hydrogen sulphide, sodium borohydride, hydrazine, a de-functionalizing agent, a decarboxylating agent, desulfonating agent, a modifying agent, a controlling agent, a denitrating agent, a modifying agent, an alkaline solution, sodium citrate, amino acids, sugars, ascorbic acid, thermal energy, a metal, zinc, magnesium, primary amine, secondary amine, tertiary amine, copper, sodalime, electromagnetism, polyphenols, tea, microorganisms, or any mixtures thereof.

3. A method for synthesis of carbon nanotube comprising:
Contacting an asphaltene derivative with one or more reducing agents selected from hydrogen sulphide, sodium borohydride, hydrazine, a de-functionalizing agent, a decarboxylating agent, desulfonating agent, a denitrating agent, a modifying agent, an alkaline solution, sodium citrate, amino acids, sugars, ascorbic acid, thermal energy, a metal, zinc, magnesium, primary amine, secondary amine, tertiary amine, copper, sodalime, electromagnetism, polyphenols, tea, microorganisms, or a mixture thereof.

4. The method according to claim 4, wherein the asphaltene derivative is a carboxylated asphaltene derivative formed by contacting an asphaltene composition with CO2.

5. The method according to claim 4, wherein the asphaltene derivative is a refluxed asphaltene derivative formed by refluxing a mixture of an asphaltene material and one or more additives.

6. The method according to claim 4, wherein the asphaltene derivative is a modified asphaltene derivative formed by contacting a refluxed asphaltene derivative with one or more modifying agents.

7. The method according to claim 4, wherein the asphaltene derivative is a controlled asphaltene derivative by contacting a modified asphaltene derivative with one or more controlling agents.

8. The one or more modifying agents according to claim 6, is selected from a metal, a catalyst, basic solution, a reducing agent, a salt solution, metal oxides, sulfides, hydrides, sodium chloride, sodium hydroxide, ammonium hydroxide, hydrochloric acid, tetrahydrofuran, amino triazole, dimethylformamide, dimethylsulfoxide, phosphines, phosphites, sulfites, sulfides, hydrosulfites, borohydrides, boranes, hydroxylamine, lithium alhydride, sodium nitrite, hydrochloric acid, copper bromide, copper cyanide, potassium iodide, borohydrides, hydrochloric acid, cyanoborohydrides, aluminum hydrides, hydroquininone, hydrogen dimethylhydrazine, N,Ndimethylhydroxylamine, methylamine, dioxane, amino acids, dimethylamine, trimethylamine taurine, methionine, potassium hydroxide, tin, methanol, alkali sulfide, distilled water, or any mixtures thereof.

9. The one or more controlling agents according to claim 6, selected from hydrochloric acid, sodium bicarbonate, methanol, dimethyl sulfoxide, sodium hydroxide, potassium hydroxide, tetrahydrofuran, dimethylformamide, alkali sulfide, dimethylsulfoxide, phosphines, phosphites, sulfites, sulfides, dioxane, hydrosulfites, borohydrides, boranes, distilled water, sodium bicarbonate or any mixtures thereof.

10. The method according to claim 1, further comprising the use of a vapor deposition technique.

11. The method according to claim 1, wherein the carbon nanotube is having a lattice structure selected from a hexagonal system, an orthorhombic system, a monoclinic system, and a triclinic system
